(19) United States
(12) Patent Application Publication
(10) Pub. No.: US 2003/0236766 A1
(43) Pub. Date: Dec. 25, 2003

(54) Identifying occurrences of selected events in a system

(76) Inventors: Zenon Fortuna, (US); Wayne J. Bowers, Fremont, CA (US)

Correspondence Address: B. Noel Kivlin, Meyertons, Hood, Kivlin, Kowert & Goetzel, P.C., P.O. Box 398, Austin, TX, 78767, US

(21) Appl. No.: 10/365,679

(22) Filed: Feb. 12, 2003

Related U.S. Application Data
(60) Provisional application No. 60/380,392, filed on May 14, 2002.

(51) Int. Cl. G06F 7/00

(52) U.S. Cl. 707/1

(57) ABSTRACT

The present invention provides a method and apparatus for identifying occurrences of selected events in a system. The method includes determining if a first pattern is stored in a log file, determining if a second pattern is stored in the log file and indicating an occurrence of the event in the processor-based system in response to determining that the first pattern and the second pattern are stored in the log file within a preselected time of each other.

### BACKGROUND OF THE INVENTION

1. Field of the Invention

This invention relates generally to processor-based systems, and, more particularly, to identifying occurrences of selected events in a processor-based system.

2. Description of the Related Art

Businesses may use processor-based systems to perform a multiplicity of tasks. These tasks may include, but are not limited to, developing new software, maintaining databases of information related to operations and management, and hosting a web server that may facilitate communications with customers.

During operation, a variety of events may occur within a processor-based system, events such as error occurrences, maintenance actions, boot sequences, and recovery steps. It may be desirable to determine when selected events, such as those mentioned above, occur to properly diagnose faults, for example, in the processor-based system. For instance, if an error occurs in the system, it may be desirable to know for diagnostic purposes whether that error occurred during a boot sequence, recovery sequence, and the like. It may also be desirable to determine the occurrence of one or more of the above-mentioned events to automate the process of testing the processor-based system.

Detecting an occurrence of a selected event, however, may not always be apparent to the end user, as the processor-based system may be executing a myriad of tasks during any given time. The problem of identifying an occurrence of a selected event may be further exacerbated by the fact that the processor-based system may not display a message to the end user indicating that the event has occurred.

### SUMMARY OF THE INVENTION

In one aspect of the instant invention, an apparatus is provided for identifying occurrences of selected events in a system. The apparatus includes a control unit communicatively coupled to a storage unit. The control unit is adapted to identify a first string in a file that is associated with an event, identify a second string in the file stored in the storage unit that is associated with the event and determine if the second string is stored in the file within a preselected time of the first string being stored in the file. The control unit further provides an indication of an occurrence of the event in response to determining that the second string is stored within the preselected time of the first second string being stored.

In one aspect of the present invention, a method is provided for identifying occurrences of selected events in a system. The method includes determining if a first pattern is stored in a log file, determining if a second pattern is stored in the log file and indicating an occurrence of the event in the processor-based system in response to determining that the first pattern and the second pattern are stored in the log file within a preselected time of each other.

In one aspect of the present invention, an article comprises one or more machine-readable storage media containing instructions that when executed enable a processor to identify occurrences of selected events in a system. The instructions when executed enable a processor to determine whether a sequence exists in a log file. The sequence comprises at least a first pattern and a second pattern and is associated with an event and indicates that the event has occurred based on determining that the sequence exists in the log file.

### BRIEF DESCRIPTION OF THE DRAWINGS

The invention may be understood by reference to the following description taken in conjunction with the accompanying drawings, in which like reference numerals identify like elements, and in which:

FIG. 1 shows a block diagram of a processor-based system that includes an event identifying module stored therein, in accordance with one embodiment of the present invention;

FIG. 2 shows a block diagram of interconnections of one or more components of the processor-based system of FIG. 1, in accordance with one embodiment of the present invention;

FIGS. 3 illustrates an exemplary log file that may be accessed by the event identifying module of FIG. 1, in accordance with one embodiment of the present invention;

FIG. 4A illustrates an exemplary record of a pattern database that may be accessed by the event identifying module of FIG. 1, in accordance with one embodiment of the present invention;

FIG. 4B illustrates an exemplary record of a sequence database that may be accessed by the event identifying module of FIG. 1, in accordance with one embodiment of the present invention;

FIG. 5 shows a flow diagram of the event identifying module of FIG. 1, in accordance with one embodiment of the present invention; and

FIG. 6 shows an alternative flow diagram of the event identifying module of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

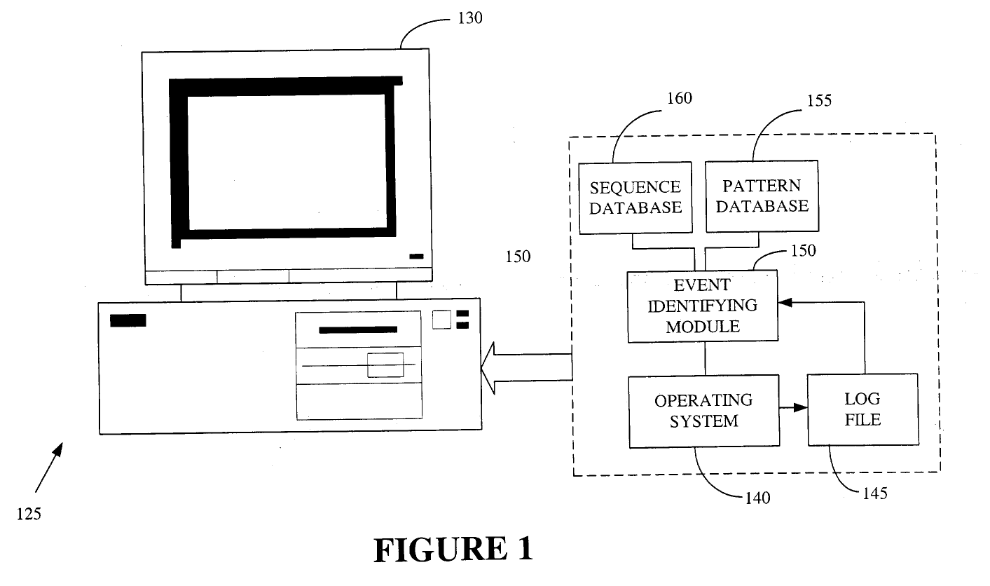

FIG. 1 shows a block diagram of a processor-based system 125, in accordance with one embodiment of the present invention. The processor-based system 125 may include a display device 130 for displaying one or more applications that are executable by the processor-based system 125. In one embodiment, the processor-based system 125 may include an operating system 140 installed therein. The operating system 140, for example, may be the Solaris® operating system, the UNIX® operating system, WINDOWS® operating system, Disk operating system (DOS®), AIX® operating system, LINUX® operating system, and the like. Although not so limited, for the purposes of this description, it is herein assumed that the processor-based system 125 includes the Solaris® operating system.

The operating system 140, in one embodiment, may store messages (or alerts) in a log file 145 related to various events that occur within the processor-based system 125. For example, the Solaris® operating system generates a “syslog” file for storing a variety of messages. In one embodiment, the log file 145 may include a plurality of log files. Although in the illustrated embodiment, the operating system 140 stores the messages in the log file 145, in an alternative embodiment, any one or more hardware or software components of the processor-based system 125 may also write to the log file 145.

The processor-based system 125 may include an event identifying (EI) module 150 that is able to access the log file 145 and search for one or more “patterns” stored in a pattern database 155. A “pattern,” as utilized herein, may include a string of characters that is capable of identifying a message that is storable in the log file 145. The processor-based system 125, in one embodiment, includes a sequence database 160 stored therein. As utilized herein, a “sequence” comprises one or more patterns that are stored in the pattern database 155, and is generally associated with a selected event that occurs in the processor-based system 125. Although two separate databases 155, 160 are illustrated in FIG. 1, it should be appreciated in an alternative embodiment, the two databases 155, 160 may be integrated into a single database. As explained in more detail below, the El module 150 is capable of determining whether one or more sequences stored in the sequence database 160 exist in the log file 145.

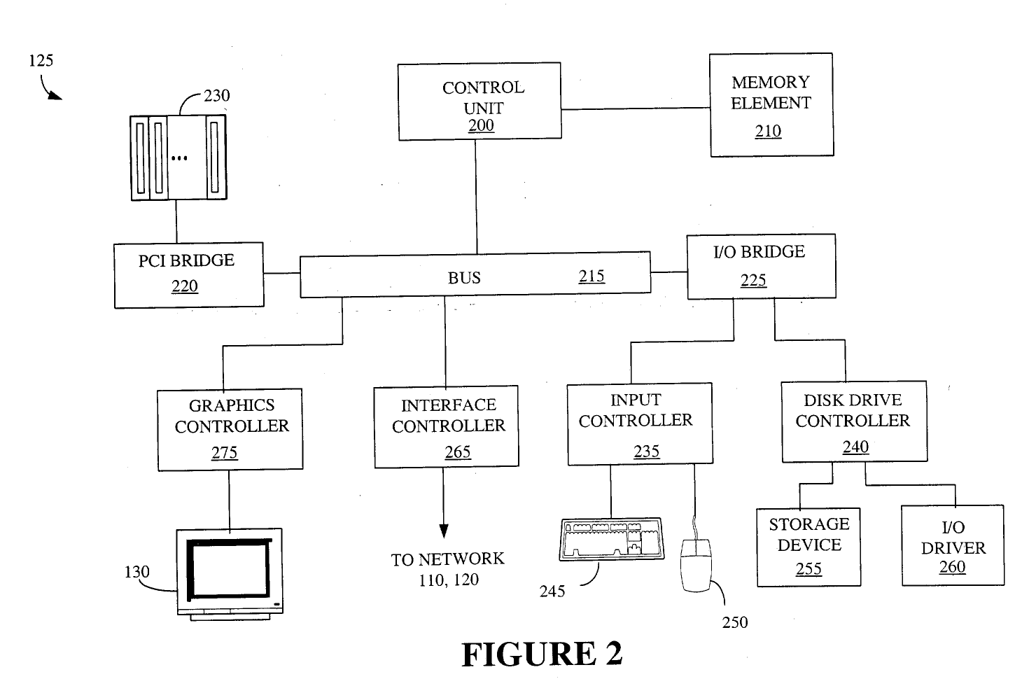

FIG. 2 shows a block diagram of one embodiment of the processor-based system 125. For example, the processor-based system 125 may be a workstation such as the Sun Blade® Workstation. The processor-based system 125 may comprise at least one control unit 200 adapted to perform one or more tasks or to spawn one or more processes. Although not so limited, in one embodiment, the control unit 200 may be a 500-MHz UltraSPARC-IIe® processor. The control unit 200 may be coupled to at least one memory element 210 adapted to store information. For example, the memory element 210 may comprise 2-gigabytes of error-correcting synchronous dynamic random access memory (SDRAM) coupled to the processor via one or more unbuffered SDRAM dual in-line memory module (DIMM) error-correcting slots (not shown).

In one embodiment, the memory element 210 may be adapted to store a variety of different forms of information including, but not limited to, one or more of a variety of software programs and data produced by the software and hardware. Although not so limited, the one or more software programs stored in the memory element 210 may include software applications (e.g., database programs, word processors, and the like) and at least a portion of an operating system (e.g., the Solaris® operating system). The code for the software programs stored in the memory element 210 may, in one embodiment, comprise one or more instructions that may be used by the control unit 200 to perform various tasks or spawn various processes.

The control unit 200 may be coupled to a bus 215 that may transmit and receive signals between the control unit 200 and any of a variety of devices that may also be coupled to the bus 215. For example, in one embodiment, the bus 215 may be a 32-bit-wide, 33-MHz peripheral component interconnect (PCI) bus. A variety of devices may be coupled to the bus 215 via one or more bridges, which may include a PCI bridge 220 and an I/O bridge 225. It should, however, be appreciated that, in alternative embodiments, the number and/or type of bridges 220, 225 may change without departing from the spirit and scope of the present invention. In one embodiment, the PCI bridge 220 may be coupled to one or more PCI slots 230 that may be adapted to receive one or more PCI cards, such as Ethernet cards, token ring cards, video and audio input, SCSI adapters, and the like.

The I/O bridge 225 may, in one embodiment, be coupled to one or more controllers, such as an input controller 235 and a disk drive controller 240. The input controller 235 may control the operation of such devices as a keyboard 245, a mouse 250, and the like. The disk drive controller 240 may similarly control the operation of a storage device 255 and an I/O driver 260 such as a tape drive, a diskette, a compact disk drive, and the like. It should, however, be appreciated that, in alternative embodiments, the number and/or type of controllers 235, 240 that may be coupled to the I/O bridge 225 may change without departing from the scope of the present invention. For example, the I/O bridge 225 may also be coupled to audio devices, diskette drives, digital video disk drives, parallel ports, serial ports, a smart card, and the like. In one embodiment, the operating system 140, the log file 145, the EI module 150, the pattern database 155, the sequence database 160, shown in FIG. 1, may be stored in the storage device 255 of the processor-based system 125.

An interface controller 265 may be coupled to the bus 215. In one embodiment, the interface controller 265 may be adapted to receive and/or transmit packets, datagrams, or other units of data over a network, in accordance with network communication protocols such as the Internet Protocol (IP). Although not so limited, in alternative embodiments, the interface controller 265 may also be coupled to one or more IEEE 1394 buses, FireWire ports, universal serial bus ports, programmable read-only-memory ports, and/or 10/100Base-T Ethernet ports.

The display device 130 may be coupled to the bus 215 via a graphics controller 275. The display device 130 may be used to display information provided by the control unit 200. For example, the display device 130 may display documents, 2-D images, or 3-D renderings.

For clarity and ease of illustration, only selected functional blocks of the processor-based system 125 are illustrated in FIG. 2, although those skilled in the art will appreciate that the processor-based system 125 may comprise additional or fewer functional blocks. Additionally, it should be appreciated that FIG. 2 illustrates one possible configuration of the processor-based system 125 and that other configurations comprising different interconnections may also be possible without deviating from the scope of the present invention. For example, in an alternative embodiment, the processor-based system 125 may include additional or fewer bridges 220, 225. As an additional example, in an alternative embodiment, the interface controller 265 may be coupled to the control unit 200 directly. Similarly, other configurations may be possible.

In the course of the normal operations of the processor-based system 125 described above, a variety of events, such as errors occurrences, maintenance actions, boot sequences, and recovery sequences, may occur. As described in more detail below, the EI module 150 identifies one or more sequences stored in the sequence database 160 (see FIG. 1) to identify occurrences of one or more events in the processor-based system 125.

The term “error” or “errors,” as utilized herein, refers to the incorrect or undesirable behavior of hardware devices or software executing in the processor-based system 125. For example, errors may comprise hardware errors such as a malfunctioning processor-based system 125 or they may comprise software errors such as an invalid request for access to a memory location. An error may cause the software, the hardware, or the system to become substantially unable to continue performing tasks.

The one or more hardware or software components (or combinations thereof) of the processor-based system 125 may generate a variety of data that is stored in the log file 145. Although not so limited, in the illustrated embodiment, the data stored in the log file 145 may include messages or alerts provided by the operating system 140 (see FIG. 1). The messages, which may be periodically removed from or added to the log file 145, may be associated with one or more events that occur in the processor-based system 125.

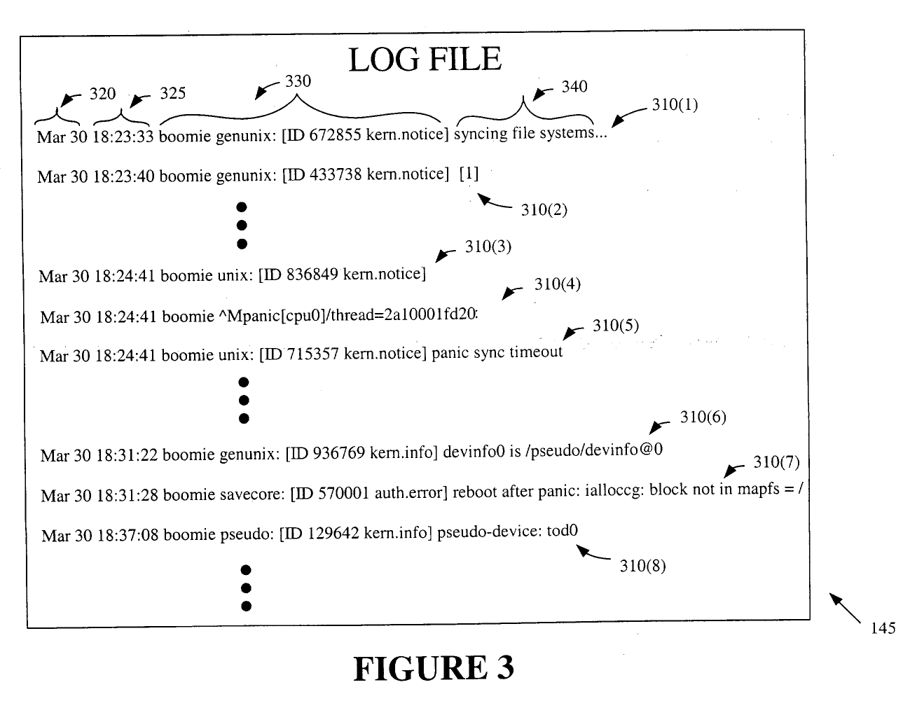

FIG. 3 illustrates the log file 145 including exemplary contents, in accordance with one embodiment of the present invention. Although not so limited, the log file 145 illustrated in FIG. 3 is a portion of an exemplary “syslog” file that is created and updated by the Solaris® operating system. As shown, the log file 145 includes a pluralities of entries 310 (shown as 310(1-8) in FIG. 3). Each entry 310 generally includes a date stamp 320 and a time stamp 325, an ID field 330, and a message field 340. For example, the entry 310(4) includes a date stamp of “March 30,” a time stamp of “18:24:41,” an ID of “boomie,” and a message of “\hat{ }Mpanic[cpu0]/thread=2a10001fd20.” This means that the message in the message field 340 of the entry 310(4) was posted on “March 30” at “18:24:41” in the log file 145 by the operating system 140 of a host machine identified as “boomie.”

The log file 145 includes a plurality of other entries 310 that are posted by the operating system 140 over time. The ID field 330 of the entries 310 in the illustrated embodiment includes a host identifier and a message identifier. The host identifier identifies the host machine, while the message identifier identifies the section of the kernel of the operating system 140 that posts the entry 310. For example, with respect to the first entry 310(1) of the log file 145, the host machine name is “boomie” and the message identifier is “672855.” When no express message identifier is provided in the ID field 330 of the entry 310, a default message identifier value of “−1” is assumed for the purposes of this discussion. For example, the message identifier for the entry 310(4) is assumed to be “−1,” as no other message ID is presented in that entry 310(4). The message identifier of the ID field 330 may vary, in one embodiment, based on the version of the operating system 140 that posts the entry 310 in the log file 145.

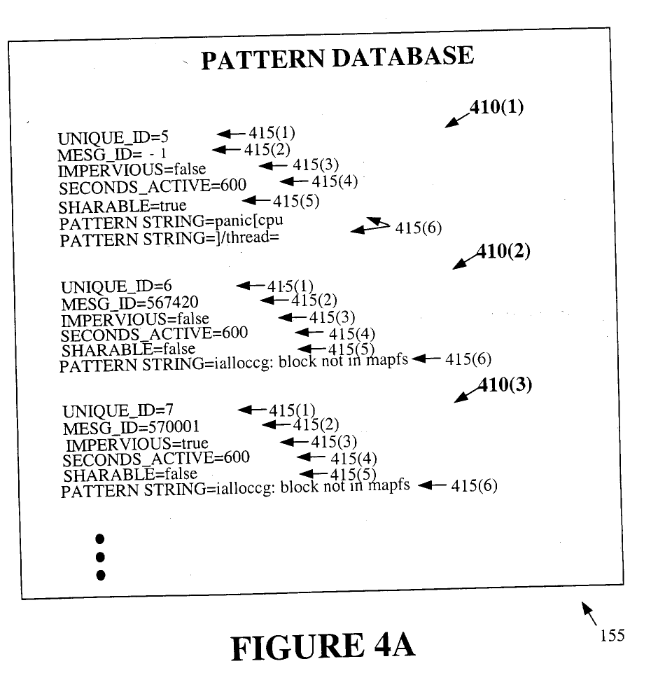

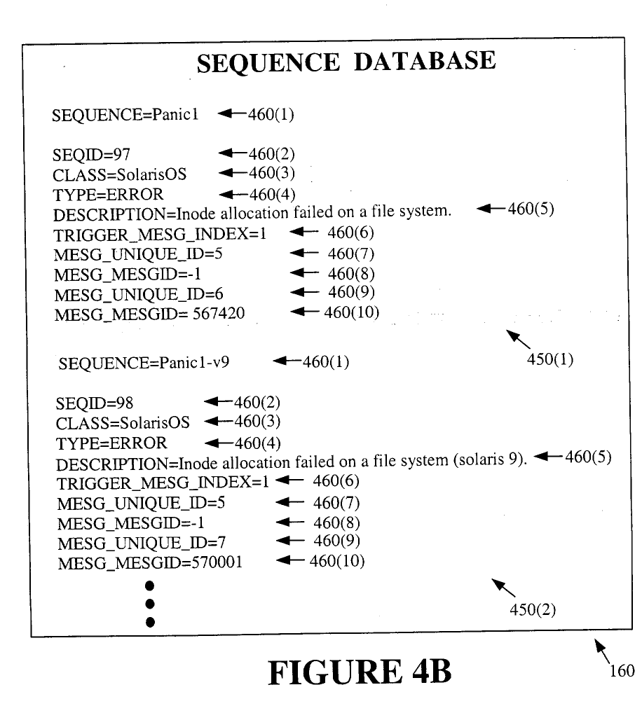

FIGS. 4A and B illustrate exemplary contents of the pattern database 155 and the sequence database 160, respectively, that may be created using the EI module 150 of FIG. 1. In the illustrated example of FIG. 4A, three patterns 410(1-3) are defined and stored in the pattern database 155. The patterns 410 may correspond to one or more messages that are storable in the log file 145 (see FIG. 3). In the illustrated example, as will be described in more detail below, the patterns 410(1) and 410(3) of FIG. 4A correspond to the entries 310(4) and 310(7), respectively, of the log file 145 of FIG. 3.

In one embodiment, the EI module 150 may allow a user to select at least a portion of a string of characters from the message field 340 of the entries 310 of the log file 145 (see FIG. 3) to define one or more “patterns” that are storable in the pattern database 155. The user, for example, may select portions of the message field 340 of the entries 310 using the mouse 250 (see FIG. 2), for instance, and then save the selected patterns 410 in the pattern database 155 using a GUI interface (not shown) of the EI module 150. Alternatively, as opposed to selecting patterns 410 from the log file 145, the user may manually enter the patterns 410 in the pattern database 155 using the GUI interface of the EI module 150.

As shown in FIG. 4A, the pattern database 155 may include one or more patterns 410(1-3) stored therein. Each pattern 410(1-3) may include a plurality of fields 415 (shown as 415(1-6) in FIG. 4A). The first field 415(1) includes a unique identifier number that is assigned by the EI module 150 to each pattern 410(1-3). Thus, as a new pattern is added to the pattern database 155, the EI module 150 increments the unique identifier by one and stores it in the first field 415(1) of that new pattern. For example, the unique identifier number of the second pattern 410(2) in the pattern database 155 is 6 (six), which is one more than the unique identifier of the first pattern 410(1). Similarly, the third pattern 410(3) in the illustrated example is assigned an identifier number of 7 (seven).

The second field 415(2) of each pattern 410 is the message identifier, which, as mentioned, identifies the portion of the kernel of the operating system 140 that posts the message corresponding to the pattern 410 in the log file 145. The third field 415(3) of each pattern 410 indicates whether the pattern 410 is impervious to a reboot, the fourth field 415(4) indicates the active state (or life span) of the pattern 410, and the fifth field 415(5) indicates if the pattern 410 is sharable. The relevance of the fields 415(3-5) is described in more detail below. The sixth field 415(6) includes one or more strings corresponding to the pattern 410. For example, the first pattern 410(1) is defined by strings “panic[cpu” and “]/thread=,” and the second and third patterns 410(2-3) are defined by the string “ialloccg: block not in mapfs.” As described below, the patterns 410(1-3) may be detected by searching for the above-mentioned respective strings in the log file 145, as well as the message identifier specified in the second field 415(2) of the patterns 410(1-3).

In the illustrated example, while both the second and third patterns 410(2-3) have the same pattern string (see the sixth field 415(6)), the two patterns 410(2-3) are nevertheless different because they each have a different message identifier (see the second field 415(2) of the patterns 410(2-3)). That is, the message identifier of the second pattern 410(2) is “567420,” while the message identifier of the third pattern 410(3) is “570001.” As mentioned, the message identifier identifies the portion of the kernel that posts the message in the log file 145. In the illustrated embodiment, the two patterns 410(2-3) have the same pattern string but different message identifiers because the messages corresponding to the patterns 410(2-3) are posted by different versions of the operating system 140 that may have been executed in the processor-based system 125 at various times.

FIG. 4B illustrates the sequence database 160 with exemplary sequences 450 (shown as sequences 450(1-2) in FIG. 4B) stored therein. As mentioned, a “sequence” includes a plurality of patterns 410 (see FIG. 4A). As shown, in the illustrated embodiment, the sequences 450 includes a plurality of fields 460(1-10) containing relevant information. The first field 460(1) includes an identifier for the sequences 450. In the illustrated example, the first sequence 450(1) is identified by the user as “Panic1,” and the second sequence 450(2) is identified as “Panic1-v9.” The second field 460(2) includes a sequence identification number that is assigned by the EI module 150 when each of the sequences 450 is defined. In one embodiment, the sequence identification number provided in the field 460(2) is unique to the sequence 450. Thus, as additional sequences 450 are added to the sequence database 160, the sequence identification number may be incremented by one, for example.

The third field 460(3) of the sequences 450 in the illustrated embodiment identifies a class to which that sequence may belong. For example, in the illustrated embodiment, both of the sequences 450 belong to a class of “SolarisOS.” The fourth field 460(4) of the sequences 450 defines the “type” of event to which each of the sequences 450 corresponds. A sequence 450 may be defined for various types of events, such as error events, boot events, recovery events, maintenance events, and the like. In other implementations, any other variety of events may be defined. The fifth field 460(5) of the sequences 450 describes the event that is associated with the sequence 450. As an example, if the first sequence 450(1) is detected in the log file 145, then it is an indication that a panic (i.e., an error state of a particular type) has occurred because of an inode allocation failure in a file system of the operating system 140.

As can been seen with reference to the fields 460(7) and 460(9), the first sequence 450(1) in the illustrated embodiment includes two patterns 410(1-2) having a unique identifier number of 5 (five) and 6 (six), respectively. These unique identifier numbers correspond to the respective first and second patterns 410(1-2) of FIG. 4A. Accordingly, in the illustrated embodiment, the two patterns 410(1-2) of FIG. 4A define the first sequence 450(1) of FIG. 4B because these patterns 410(1-2) have the unique identifier numbers of 5 and 6, respectively. The first sequence 450(1) is detected when the EI module 150 finds both of the patterns 410(1-2) in the log file 145 within a preselected time of each other, as described in greater detail below. In one embodiment, the order in which the patterns 410(12) are listed in the first sequence 450(1-2) may be material to the order in which these patterns 410(1-2) should be found in the log file 145.

In the illustrated example, as can be seen with reference to the fields 460(7) and 460(9), the second sequence 450(2) includes two patterns having a unique identifier number of 5 (five) and 7 (seven), respectively. These unique identifier numbers correspond to the respective first and third patterns 410(1) and 410(3) of FIG. 4A. Accordingly, in the illustrated embodiment, the two patterns 410(1) and 410(3) of FIG. 4A define the second sequence 450(2) of FIG. 4B.

The sequences 450 also include the fields 460(8) and 460(10), which contain the message identifiers for the patterns 410 identified in the fields 460(7) and 460(9). As can be seen with reference to the first sequence 450(1) of FIG. 4B, the first pattern 410(1) with a unique identifier of “5” has a message identifier of “−1” in the field 460(8), and the second pattern 410(2) with a unique identifier of “6” has a message identifier of “567420” in the field 460(10). Additionally, in FIG. 4B, the first pattern 410(1) of the second sequence 450(2) with a unique identifier of “5” has a message identifier of “−1” in the field 460(8), and the third pattern 410(3) with a unique identifier of “7” has a message identifier of “570001” in the field 460(10). As can be seen, the message identifiers stored in the fields 460(8) and 460(10) of the sequences 450(1-2) of FIG. 4B correspond to the message identifiers of the patterns 410(1-3) that are stored in the pattern database 155 of FIG. 4A.

As mentioned, sequences 450, which comprise a plurality of patterns 410, generally indicate an occurrence of an event in the processor-based system 125. In the illustrated example, the first sequence 450(1) comprises the patterns 410(1-2) and the second sequence 450(2) comprises the patterns 410(1) and 410(3). The sequences 450(1-2), when detected in the illustrated example, indicate that a panic event has occurred due to an ‘inode’ allocation failure on a file system, albeit for different versions of the operating systems.

To identify the time and date at which the event occurs, the sequences 450 include the sixth field 460(6) (i.e., “TRIGGER_MESG_INDEX). The sixth field 460(6) designates which of the patterns 410 of that sequence 450 should be used to identify the time and date of the event. For example, as can be seen, the sixth field 460(6) of the first sequence 450(1) is “1” This means that the time and date stamp 320, 325 of the entry 310 in the log file 145 corresponding to the first pattern 410(1) identifies the time and date the event is deemed to have occurred in the processor-based system 125. Thus, if the sixth field 460(6) of the first sequence 450(1) were “2,” then the time and date stamp 320, 325 of the entry 310 in the log file 145 that corresponds to the second pattern 410(2) would be used to indicate the time and date the event is deemed to have occurred in the processor-based system 125.

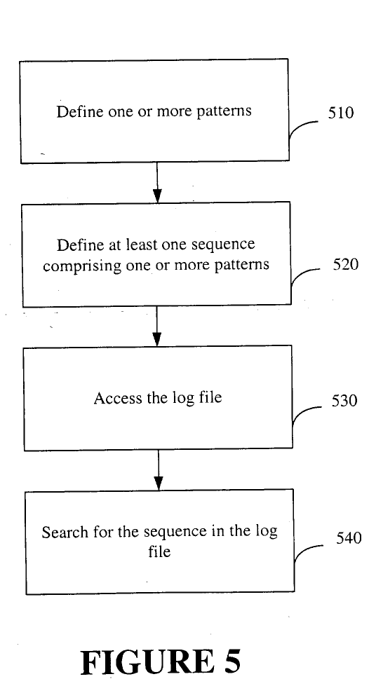

Referring now to FIG. 5, a flow diagram of the EI module 150 is illustrated, in accordance with one embodiment of the present invention. For ease of illustration, the EI module 150 is described with reference to the exemplary log file 145 of FIG. 3 and the exemplary pattern and sequence databases 155, 160 of FIGS. 4A-B. It should, however, be appreciated that the types of patterns 410 and sequences 450 that may be defined to identify desired events may vary from one implementation to another.

A user defines (at 510), using the EI module 150, one or more patterns 410 in the pattern database 155. The various ways in which the patterns 410 may be defined is described earlier. In the illustrated example of FIG. 4A, three patterns 410(1-3) are defined and stored in the pattern database 155.

The user defines (at 520), using the EI module 150, at least one sequence 450 comprising two or more of the defined patterns 410. In the illustrated example of FIG. 4B, two sequences 450(1-2) are defined, where the first sequence 450(1) comprises the patterns 410(1) and 410(2), and the second sequence 450(2) comprises the patterns 410(1) and 410(3).

The EI module 150 accesses (at 530) the log file 145 and searches (at 540) the log file 145 for the sequences 450(1-2) that are defined (at 520) in the sequence database 160. As mentioned, the sequences 450(1-2) are typically associated with at least one event that may occur in the processor-based system 125. For example, the detection of the second sequence 450(2) may signify that an “inode” allocation failure of the file system in the operating system (e.g., Solaris® version 9.0) likely occurred in the processor-based system 125. Similarly, other sequences 450 may be defined to detect the occurrence of other desired events in the processor-based system 125.

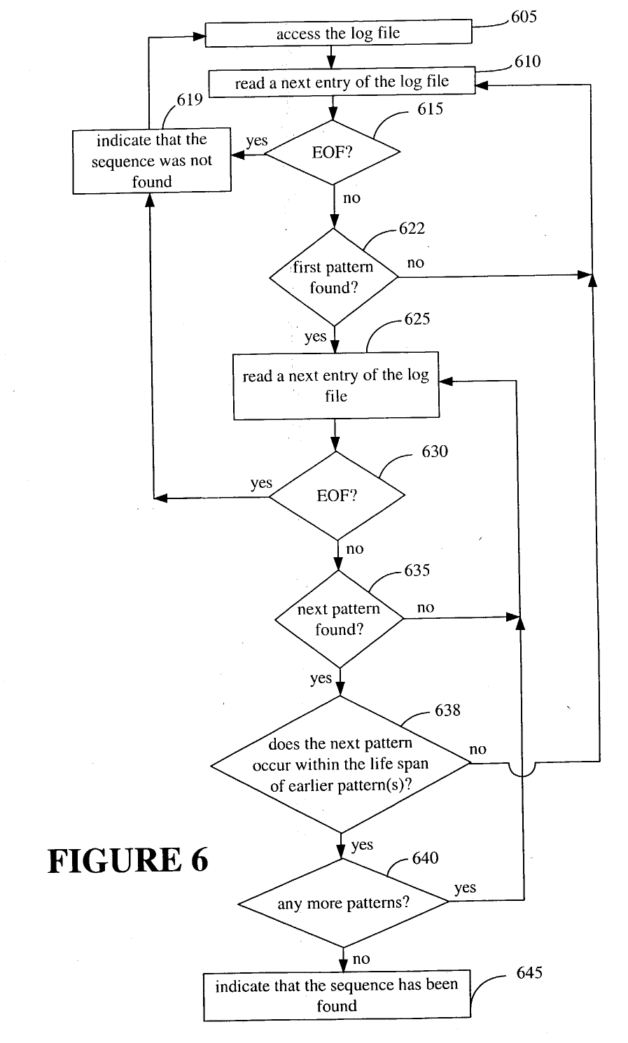

FIG. 6 includes a flow diagram of the block of 540 of FIG. 5, in accordance with one embodiment of the present invention. By way of example, FIG. 6 is described in the context of the EI module 150 searching for the first and second sequences 450(1-2) that are stored in the sequence database 160 of FIG. 4B in the log file 145 of FIG. 3.

The search for the first sequence 450(1) in the log file 145 is described first. As mentioned, the first sequence 450(1) comprises two patterns 410(1) and 410(2). The first pattern 410(1), which has a message identifier of “−1” (see field 415(2) of FIG. 4A), comprises the character strings “panic[cpu” and “]/thread=” as noted in the field 415(6). For the purposes of this description, it should be appreciated that any references to searching for a particular pattern 410 in the log file 145 includes searching for the message identifier and one or more strings associated with that pattern 410.

The EI module 150 accesses (at 605) the log file 145 to read at least a portion of the contents stored therein. The EI module 150 reads (at 610) an entry 310 (see FIG. 3) from the log file 145. The EI module 150 determines (at 615) if the entry 310 contains an end of file (EOF) character. If the end of the log file 145 is reached, then the EI module 150, in one embodiment, indicates (at 619) that the first sequence 450(1) has not been found because at least the first pattern 410(1) of the first sequence 450(1) does not exist in the log file 145. The log file 145 may be updated by the operating system 140 on a continuous basis, as events occur in the processor-based system 125. As such, in one embodiment, the EI module 150 may again access (at 605) the log file 145 to search for the first pattern 410(1) in the updated log file 145.

If the EI module 150 determines (at 615) that the entry read (at 610) does not include an EOF character, then the EI module 150 determines (at 622) whether the entry read (at 615) contains the first pattern 410(1) of the first sequence 450(1). As indicated, searching for a pattern 410, in one embodiment, comprises searching for the message identifier and one or more strings associated with that pattern 410. For example, the first pattern 410(1) may be detected in the illustrated embodiment when the message identifier of “−1” and the strings “panic[cpu” and “]/thread=” are detected in the entry that is read (at 610).

In the exemplary log file 145 of FIG. 3, the strings (e.g., “panic[cpu” and “]/thread=”) and the message identifier (e.g.,“−1”) associated with the first pattern 410(1) exist in the entry 310(4). As discussed above, because no express message identifier is provided in the entry 310(4), the message identifier in the entry 310(4) is assumed to be “−1” by default. Accordingly, because the character strings and the message identifier associated with the first pattern 410(1) of the first sequence 450(1) are present in the entry 310(4) of the log file 145, in this example, the first pattern 410(1) is present in the file log 145 of FIG. 3.

Upon detecting the first pattern 410(1) (at 622), the EI module 150 reads (at 625) a next entry 310 of the log file 145. The EI module 150 determines (at 630) if the entry 310 contains an end of file (EOF) character. If the end of the log file 145 is reached, then the EI module 150, in one embodiment, indicates (at 619) that the first sequence 450(1) was not detected in the log file 145 because the next pattern 410 (which happens to be the second pattern 410(2) in this example) was not found in the log file 145. In one embodiment, the EI module 150 may access (at 605) the log file 145 to search again for the first pattern 450(1) after the log file 145 has been updated with new entries 310 by the operating system 140.

If the EI module 150 determines (at 630) that the entry read (at 625) does not include an EOF character, then the EI module determines (at 635) whether the entry read (at 625) contains the next pattern 410 (i.e., the second pattern 410(2), in this example) of the first sequence 450(1). As shown in FIG. 4A, the string of characters associated with the second pattern 410(2) is “ialloccg: block not in mapfs” and the associated message identifier is “567420.” Thus, the EI module 150 determines (at 635) if the string of characters “ialloccg: block not in mapfs” and the associated message identifier is “567420” are in the entry read (at 625). This above process continues until either the second pattern 410(2) is found or the end of the log file 145 is reached.

In the log file 145 of FIG. 3, while the entry 310(7) includes the character string “ialloccg: block not in mapfs” that matches the character string of the second pattern 410(2) of FIG. 4A, the message identifier (i.e.,“570001”) of that entry 310(7) does not match the message identifier (i.e., “567420”) of the second pattern 410(2). Accordingly, the second pattern 410(2) does not exist in the log file 145. And because the second pattern 410(2) of the first sequence 450(1) is not found in the log file 145, the first sequence 450(1) is likewise not detected. Thus, the EI module 150, in one embodiment, indicates (at 619) that the first sequence 450(1) was not detected, and, accordingly, no event associated with the first sequence 450(1) likely occurred in the processor-based system 125.

The method of FIG. 6 is now described with respect to the search for the second sequence 450(2) (see FIG. 4B), which, as mentioned, comprises the first pattern 410(1) and the third pattern 410(3) of FIG. 4A. Thus, the first and second sequence 450(1-2) both comprise the first pattern 410(1). Accordingly, the first pattern 410(1) of the second sequence 450(2) is detected in the log file 145 in a similar manner as described earlier with respect to the first sequence 450(1). As such, upon detecting the first pattern 410(1) (at 622), the EI module 150 reads (at 625) the next entry 310 in the log file 145 to search for the next pattern 410 (i.e., the third pattern 410(3), in this example) of the second sequence 450(2).

The EI module 150 determines (at 630) whether the entry 310 read (at 625) contains an end of file (EOF) character. If the end of the log file 145 is reached, then the EI module 150, in one embodiment, indicates (at 619) that the second sequence 450(2) was not detected in the log file 145 because the next pattern 410 (which happens to be the third pattern 410(3) in this example) was not found in the log file 145. In one embodiment, the EI module 150 may then access (at 605) the log file 145 to search again for the second sequence 450(2), starting from the first pattern 410(1) after the log file 145 has been updated with new entries 310 by the operating system 140. In the illustrated example, however, as can be seen in FIG. 3, the entry 310(7) of the log file 145 does in fact include the string ““ialloccg: block not in mapfs” and the message identifier “570001” that is associated with the pattern 410(3) of the second sequence 450(2). Accordingly, the pattern 410(3) is found in the entry 310(7) of the log file 145.

The EI module 150 determines (at 638) whether the pattern 410(3) of the second sequence 450(2) occurs within the life span of the earlier pattern 410 (i.e., which is the pattern 410(1), in this example). The life span of the first pattern 410(1) is specified in the field 415(4) of the pattern database 155 of FIG. 4A. As can be seen, the life span of the first pattern 410(1) in the illustrated example is 600 seconds, which indicates the amount of time the first pattern 410(1) is considered to be “alive.” If 600 seconds have elapsed since the last detection of the first pattern 410(1), then that detection of the first pattern 410(1) is discarded, and the search for the first pattern 410(1) begins again because the earlier detected first pattern 410(1) is deemed to have expired. Accordingly, if the EI module 150 were to determine (at 638) that the second pattern 410(2) did not occur within the life span of the first pattern 410(1), the EI module 150 may once again begin a search for the first pattern 410(1).

In one embodiment, the elapsed time between the detection of the patterns 410 may be calculated based on the time and date stamps 320, 325 (see FIG. 3) of the entries 310 associated with those patterns 410. For example, as shown in the entries 310(4) and 310(7) of FIG. 3, the first pattern 410(1) is saved at time “18:24:41” on “March 30,” and the second pattern 410(2) is saved at time “18:31:28” on “March 30.” In the illustrated embodiment of the log file 145 of FIG. 3, the second pattern 410(2) occurs within 600 seconds or less of the first pattern 410(1). Accordingly, because the first pattern 410(1) is still alive at the time the second pattern 410(2) is recorded, the second pattern 410(2) is construed to have occurred within the life span of the first pattern 410(1).

If the EI module 150 determines (at 638) that the second pattern 410(2) is found in the log file 145 while the first pattern 410(1) is alive, then the EI module 150 determines (at 640) if any more patterns 410 exist in the second sequence 450(2). In the illustrated embodiment, as mentioned, the second sequence 450(2) includes only two patterns 410(1) and 410(3). Accordingly, because both of the patterns 410(1) and 410(3) of the second sequence 450(2) exist in the log file 145, the EI module 150 indicates (at 645) the presence of the second sequence 450(2) in the log file 145. In one embodiment, the EI module 150 may indicate (at 645) that the event (i.e., inode allocation failure in the operating system version 9) associated with the second sequence 450(2) occurred in the processor-based system 125. Furthermore, the EI module 150 may specify the time and date the event occurred based on the “TRIGGER_MESG_INDEX” field 460(6) of the second sequence 450(2) in FIG. 4B. In the illustrated example, because the field 460(6) indicates a “1,” the time and date stamp 320, 325 in the entry 310(4) (see FIG. 3) that is associated with the first pattern 410(1) (as opposed to the other pattern 410(3)) is utilized. Accordingly, the event is deemed to have occurred at the time 18:24:41 on March 30.

In the illustrated embodiment, the second sequence 450(2) includes two patterns 410(1) and 410(3). However, assuming that a sequence 450 includes more than two patterns 410, then the EI module 150, in one embodiment, repeats one or more of the acts of the method of FIG. 6 until either all of the patterns 410 are detected or until the end of the log file 145 is reached. If the patterns 410 are found in the log file 145, the EI module 150 determines (at 638) if all of the patterns are found within the life span of the earlier patterns 410. This means that all of the earlier detected patterns 410 should be alive by the time the last pattern 410 is detected to successfully detect the occurrence of a sequence 450. If the life span of one or more of the earlier detected patterns 410 expires before the last pattern 410 is detected, then, in one embodiment, the sequence 450 is deemed not to have been detected, and the search process for the sequence 450 begins again, starting with the first pattern 410 of the sequence 450.

A variety of conditions associated with a pattern 410 may be utilized when searching for sequences 450. For example, as described above, a pattern 410 may have an associated life span, after the expiration of which the pattern 410 must be detected again. An additional example of a condition that may be associated with a pattern 410 includes that pattern's imperviousness to a boot. For example, if the impervious field 415(3) (see FIG. 4A) of a pattern 410 is set to “true,” then that means that the occurrence of that pattern 410 is counted even if a boot occurs between that pattern 410 and the next pattern 410 of the same sequence. On the other hand, if the impervious field 415(3) of the pattern 410 is set to “false,” then the occurrence of that pattern 410 in the log file 145 is negated if followed by a boot sequence. As such, to detect a sequence 450 that has patterns 410 with the impervious field 415(3) set to “false,” all of the patterns 410 would have to be detected without an intervening boot sequence. Another example of a condition that may be associated with a pattern 410 is whether that pattern 410 may be “sharable” by other sequences. For example, if the sharable field 415(5) (see FIG. 4A) of the pattern 410 belonging to a selected sequence 450 is set to “false,” then the detection of that pattern 410 in the log file 145 may not be used for detection of any other sequence 450 except for that selected sequence 450. Other types of conditions associated with the patterns 410 may similarly be employed in other implementations without deviating from the spirit and scope of the present invention.

It should be noted that while the method of FIG. 6 is described with respect to searching one sequence 450 at a time, in an alternative embodiment, the EI module 150 may search for one or more sequences 450 at any given time. For example, in the processing of searching for the occurrence of the first sequence 450(1), a boot sequence may be detected between the occurrence of the first pattern 410(1) and the second pattern 410(2) of the first sequence 450(1).

The various system layers, routines, or modules may be executable by the control unit 200 (see FIG. 2). As utilized herein, the term “control unit” may include a microprocessor, a microcontroller, a digital signal processor, a processor card (including one or more microprocessors or controllers), or other control or computing devices. The storage device 255 (see FIG. 2) referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for detecting an occurrence of an event in a processor-based system, comprising:
determining if a first pattern is stored in a log file;
determining if a second pattern is stored in the log file; and
indicating an occurrence of the event in the processor-based system in response to determining that the first pattern and the second pattern are stored in the log file within a preselected time of each other.

2. The method of claim 1, wherein the first pattern has an associated time that the first pattern stored in the log file and the second pattern has an associated time that the second pattern is stored in the log file, wherein determining that the first and second patterns are stored in the log file within the preselected time comprises determining if the associated times of the first and second patterns is less than or equal to the preselected time.

3. The method of claim 1, further determining if a boot sequence occurred between the first pattern and the second pattern.

4. The method of claim 3, further providing a time the event occurs in the processor-based system.

5. The method of claim 3, wherein providing the time the event occurs comprises providing a time stamp associated with at least one of the first and second patterns in the log file.

6. The method of claim 1, wherein determining the first pattern comprises determining the first pattern that is associated with an occurrence of at least one of an error, boot, recovery, and maintenance sequence.

7. The method of claim 1, further comprising determining if a third pattern is stored in the log file within the preselected time of when the first pattern is stored in the log file.

8. The method of claim 7, further comprising determining if the third pattern is stored in the log file within a second preselected time of when the second pattern is stored in the log file.

9. The method of claim 8, further comprising indicating an occurrence of the event in response to determining that the third pattern is stored in the log file within the preselected time of when the first pattern is stored in the log file and within the second preselected time of when the second pattern is stored in the log file.

10. An apparatus, comprising:
a storage unit; and
a control unit communicatively coupled to the storage unit, wherein the control unit is adapted to:
identify a first string in a file stored in the storage unit, wherein the first string is associated with an event;
identify a second string in the file, wherein the second string is associated with the event;
determine if the second string is stored in the file within a preselected time of the first string being stored in the file; and
provide an indication of an occurrence of the event in response to determining that the second string is stored within the preselected time of the first second string being stored.

11. The apparatus of claim 10, wherein the storage unit is adapted to store the first string, the second string, and the file.

12. The apparatus of claim 11, wherein the storage unit comprises a database stored therein, wherein the database comprises the first and second strings.

13. The apparatus of claim 10, wherein the first string is associated with a first sequence, wherein the control unit is further adapted to indicate whether the first string may be shared by another sequence.

14. The apparatus of claim 10, wherein the control unit is further adapted to determine if a reboot occurs after the first string is stored and before the second string is stored in the log file.

15. The apparatus of claim 10, wherein the first string and the second string each has a time stamp associated therewith, and wherein the control unit is adapted to determine whether the time difference between the time stamps is less than or equal to the preselected time.

16. The apparatus of claim 10, wherein the control unit is further adapted to determine whether a third string is stored in the file within the preselected time of when the first string is stored in the file.

17. The apparatus of claim 16, wherein the control unit is adapted to indicate that the occurrence of the event in response to determining that the third string is stored in the file within the preselected time of when the first string is stored in the file.

18. An article comprising one or more machine-readable storage media containing instructions that when executed enable a processor to:
determine whether a sequence exists in a log file, where the sequence comprises at least a first pattern and a second pattern and is associated with an event; and
indicate that the event has occurred based on determining that the sequence exists in the log file.

19. The article of claim 18, wherein the instructions when executed enable the processor to determine whether the first pattern and the second pattern of the sequence occur within a preselected time interval.

20. The article of claim 19, wherein the instructions when executed enable the processor to allow a user to define the sequence based on the contents of the log file.

21. The article of claim 18, wherein the instructions when executed enable the processor to determine the sequence that is associated with at least one of an error event, boot event, recovery invent, and maintenance event.

22. The article of claim 18, wherein the instructions when executed enable the processor to determine whether the sequence exists in one or more log files created by an operating system.

23. The article of claim 18, wherein the instructions when executed enable the processor to store a message in a file indicating that the event has occurred.

24. The article of claim 18, wherein the instructions when executed enable the processor to determine if the sequence exists in the log file, wherein the sequence includes a third pattern.

25. An apparatus for detecting an occurrence of an event in a processor-based system, comprising:
means for determining if a first pattern is stored in a log file;
means for determining if a second pattern is stored in the log file; and
means for indicating that the event occurred in the processor-based system in response to determining that the first pattern and the second pattern are stored in the log file within a preselected time of each other.

26. The apparatus of claim 25, further comprising means for determining if a third pattern is stored in the log file within the first preselected time of the first pattern and a second preselected time of the second pattern.

27. A method, comprising:
defining a first pattern of a sequence, wherein the first pattern has an associated life span;
defining a second pattern of the sequence; and
searching for the first pattern;
searching for the second pattern in response to locating the first pattern; and
indicating that the sequence was detected in response to determining that the second pattern occurred within the life span of the first pattern.

28. The method of claim 27, wherein searching for the first pattern comprises determining a time the first pattern occurred and searching for the second pattern comprises determining a time the second pattern occurred.

29. The method of claim 28, wherein determining that the second pattern occurred within the life span of the first pattern comprises:
determining a time difference between the time the second pattern occurred and the time the first pattern occurred; and
determining if the time difference is less than the life span of the first pattern.
